(19) United States
(12) Patent Application Publication
(10) Pub. No.: US 2014/0137273 A1
(43) Pub. Date: May 15, 2014

(54) SYSTEM AND METHOD FOR SECURING THE UPLOAD OF FILES FROM A SYSTEM SERVER

(71) Applicant: APPSENSE LIMITED, Warrington (GB)

(72) Inventor: Antony WORKMAN, Bolton (GB)

(73) Assignee: APPSENSE LIMITED, Warrington (GB)

(21) Appl. No.: 13/675,848

(22) Filed: Nov. 13, 2012

(51) Int. Cl. G06F 21/60

(52) U.S. Cl. CPC G06F 21/60
USPC 726/32

(57) ABSTRACT

Embodiments of the invention include a system and method to prevent a user from copying and storing files on a third party storage device or a user's personal computer. To do this, the system and method may perform a process of connecting the authorized user to the company's computer storage to access computer files for modification and, if the authorized user attempts to copy the file to the user's computer or a third party storage site, determining whether the file should be copied. To determine whether the file should be copied, the system may use inspection modules that inspect the data files to determine whether or not the user has been restricted from copying the data file.

### FIELD OF INVENTION

The invention relates generally to data security and more particularly to a system, method, and computer program product of securing a server against unauthorized file uploads to a shared computing environment by one or more authorized system users.

### BACKGROUND OF THE INVENTION

In a typical computer network, network security is provided using, for example, a firewall. A firewall can be one of several security types (e.g., a packet filter, a network layer filter, a proxy server, etc.). As one skilled in the art will appreciate, a communications network interfaces with a computer server via the firewall and a web server to provide a secure access point for a plurality of users and to prevent users from accessing the various protected databases in the system. The firewall may be a network layer firewall (e.g., packet filter firewalls, application level firewalls, or proxy servers). A packet filter firewall blocks certain source Internet Protocol (IP) addresses, although in some embodiments, can be used to block traffic from particular source ports, destination IP addresses or ports, or destination service like www or FTP. An application layer firewall may be used to intercept all packets traveling to or from the system, and may be used to prevent certain users from accessing the system. Still, a proxy server may act as a firewall by responding to some input packets and blocking other packets (e.g., based upon content filtering). Firewalls are effective in preventing users from accessing all or portions of databases and servers that they do not have permissions to access and/or blocking content from being uploaded to the server. However, they are ineffective in preventing an authorized user from copying company information from the server.

In conjunction with or alternative to the firewall, a computer server may be protected from dangerous uploads via a virus scanner. A virus scanner scans a particular file for viruses, worms or other material that may infect the server and prevents infected documents from being uploaded to the system. While virus scanners can be effective in preventing the upload of certain dangerous files, virus scanners are not effective in preventing users from copying data from a server to which they have access (e.g., a shared server in a computing cloud).

A need exists, therefore, for a system, method and computer program product that solves the issues identified above.

### SUMMARY OF INVENTION

In accordance with the disclosed subject matter, a system, method and computer program product are provided for securing a server against unauthorized file uploads to a shared computing environment by one or more authorized system users.

Embodiments of the invention include a system for storing data file and such a system may comprise a computer having a processor and a tangible, non-transitory computer memory with instructions operable therein for performing a process of connecting a user to a storage device and a process of determining whether a data file selected by the user can be copied from the storage device to a third party storage device. In some embodiments. the instructions may comprise the steps of determining whether the user is attempting to access the storage device to copy the selected data file to the third party storage device; determining at least one of: whether the user is authorized to copy the selected data file to the third party storage device, whether the selected data file is of a type that cannot be copied to the third party storage device, and whether the selected data file includes restricted data that cannot be copied to the third party storage device; and preventing the user from copying the selected data file to the third party storage device when the computer determines that at least one of: the user is not authorized to copy the selected data file, the selected data file is of the type that cannot be copied, and the selected data file includes restricted data.

Other embodiments of the invention include a computer program product operable on a computer having a tangible, non-transitory computer memory. The computer program product may cause the computer to perform a process of connecting a user to a storage device and a process of determining whether a data file selected by the user can be copied from the storage device to a third party storage device. The computer program product may execute instructions comprising the steps of: determining whether the user is attempting to access the storage device to copy the selected data file to the third party storage device; determining at least one of: whether the user is authorized to copy the selected data file to the third party storage device, whether the selected data file is of a type that cannot be copied to the third party storage device, and whether the selected data file includes restricted data that cannot be copied to the third party storage device; and preventing the user from copying the selected data file to the third party storage device when the computer determines that at least one of: the user is not authorized to copy the selected data file, the selected data file is of the type that cannot be copied, and the selected data file includes restricted data.

Embodiments of the invention include a computer implemented method that causes a computer to perform a process of connecting a user to a storage device and a process of determining whether a data file selected by the user can be copied from the storage device to a third party storage device. The computer-implemented method may comprise the steps of: determining whether the user is attempting to access the storage device to copy the selected data file to the third party storage device; determining at least one of: whether the user is authorized to copy the selected data file to the third party storage device, whether the selected data file is of a type that cannot be copied to the third party storage device, and whether the selected data file includes restricted data that cannot be copied to the third party storage device; and preventing the user from copying the selected data file to the third party storage device when the computer determines that at least one of: the user is not authorized to copy the selected data file, the selected data file is of the type that cannot be copied, and the selected data file includes restricted data.

There has thus been outlined, rather broadly, the features of the disclosed subject matter in order that the detailed description thereof that follows may be better understood, and in order that the present contribution to the art may be better appreciated. There are, of course, additional features of the disclosed subject matter that will be described hereinafter and which will form the subject matter of the claims appended hereto.

In this respect, before explaining at least one embodiment of the disclosed subject matter in detail, it is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the disclosed subject matter. It is important, therefore, that the claims be regarded as including such equivalent constructions insofar as they do not depart from the spirit and scope of the disclosed subject matter.

These together with the other objects of the disclosed subject matter, along with the various features of novelty which characterize the disclosed subject matter, are pointed out with particularity in the claims annexed to and forming a part of this disclosure. For a better understanding of the disclosed subject matter, its operating advantages and the specific objects attained by its uses, reference should be had to the accompanying drawings and descriptive matter in which there are illustrated preferred embodiments of the disclosed subject matter.

### BRIEF DESCRIPTION OF THE DRAWINGS

So that the features and advantages of the invention may be understood in more detail, a more particular description of the invention briefly summarized above may be had by reference to the appended drawings, which form a part of this specification. It is to be noted, however, that the drawings illustrate only various embodiments of the invention and are therefore not to be considered limiting of the invention's scope as it may include other effective embodiments as well.

FIG. 1 is a network diagram of a file protection system according to an embodiment of the invention;

FIG. 2 is an electronic block diagram of a company computer for providing access to the system according to an embodiment of the invention;

FIG. 3 is a software block diagram of a company computer having a program product in memory thereon including several operation modules according to an embodiment of the invention;

FIG. 4A is a software flow diagram for obtaining a user account login and account settings according to an embodiment of the invention;

FIG. 4B is a software flow diagram for associating the user to a plurality of attributes, file types and permissions according to an embodiment of the invention;

FIG. 4C is a software flow diagram for inspecting a file that a user is attempting to copy according to the attributes, file types and permissions associated with the user according to an embodiment of the invention;

FIG. 4D is a software flow diagram for displaying to the user the results of the inspection according to an embodiment of the invention;

FIG. 5 is a logical flow diagram for inspecting a file before allowing the user to copy the file according to an embodiment of the invention;

FIG. 6 is a system database diagram for data stored in the memory of a company computer for a database according to an embodiment of the invention; and

FIG. 7 is a graphical user interface (“GUI”) displaying the result of the inspection to the user according to an embodiment of the invention.

### DETAILED DESCRIPTION

In the following description, numerous specific details are set forth regarding the systems and methods of the disclosed subject matter and the environment in which such systems and methods may operate, etc., in order to provide a thorough understanding of the disclosed subject matter. It will be apparent to one skilled in the art, however, that the disclosed subject matter may be practiced without such specific details, and that certain features, which are well known in the art, are not described in detail in order to avoid complication of the disclosed subject matter. In addition, it will be understood that the examples provided below are exemplary, and that it is contemplated that there are other systems and methods that are within the scope of the disclosed subject matter.

To address the needs discussed above, embodiments of the invention include a system for allowing a company or organization to secure data files located in computer storage and prevent users authorized to access the company computer from copying restricted files. As such, the system may prevent a user from copying and storing files on, for example, a third party storage device or a user's personal computer. In some embodiments of the invention, the system performs a process of connecting the authorized user to the company's computer storage to access computer files for modification. If the authorized user attempts to copy the file to the user's computer or a third party storage site, the system then performs a process of determining whether the file should be copied. To determine whether the file should be copied, the system may use one or more inspection modules that inspect the data files to determine whether or not the data file is restricted. For example, in some embodiments, the company may restrict the user from copying files that contain restricted content, files that are not associated with the user and/or files that the specific user is not authorized to copy. In some embodiments, the system may also include an override feature so that a system administrator can enable the user to copy files that the inspection modules determined the user was restricted from copying. As one skilled in the art will appreciate, embodiments of the invention the system can be customized for the particular company or organization (e.g., the inspection modules can be company-defined).

As will be understood by those of skill in the art, the term “company computer” may be a computer or network associated with a particular company or organization. As such, the term “company computer” is not limited to commercial companies, but may include other organizations such as education institutions, charities, non-profit groups, government entities, financial institutions, etc. Moreover, the terms “company” and “organization” should not be limited to a single entity, but can include multiple entities, corporations, organizations, charities and/or individuals having access to a secure server and database. As such, in some embodiments, the company computer may be a shared server or social media site where one or more users can upload and share computer content. In addition, while the term “upload” is used to describe the copying of a file from a company computer, the term “upload” may include remote uploading, downloading and sideloading, and as such is not limited to copying company computer files to a remote system (e.g., the term can refer to copying computer files to a personal computer memory, USB thumb drive, compact disk, remote storage server, local storage server, etc.).

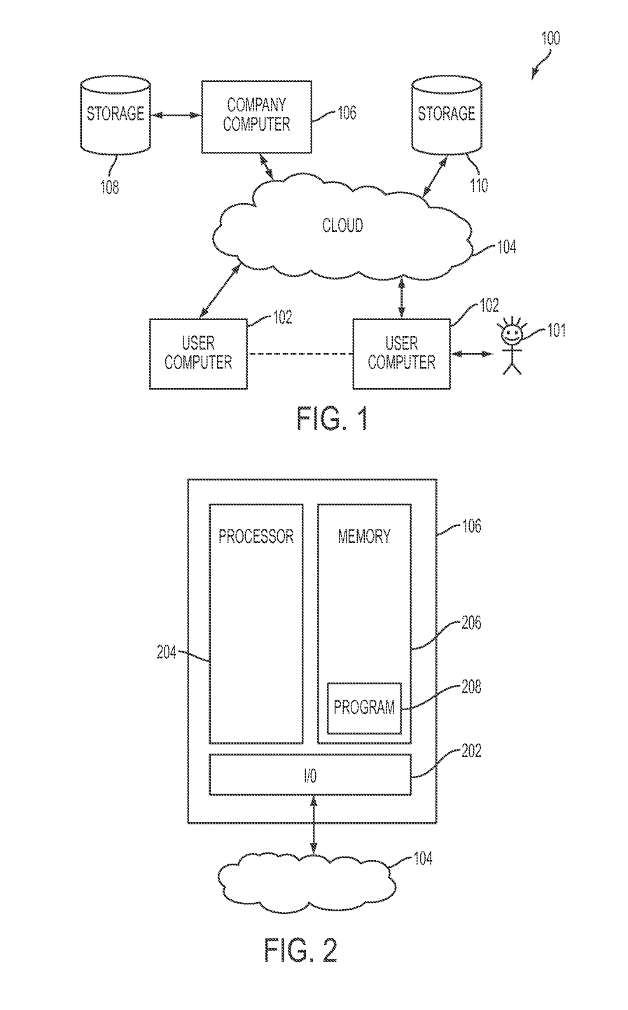

FIG. 1 is a system diagram according to an embodiment of the invention. System 100 of the present invention includes one or more user computers 102 associated with a user 101 to enable the user to access a company computer 106. A communications network 104 is positioned between the user computer 102 and the company computer 106 to provide the user 101 remote access to the company computer 106 (e.g., so that the user and the company do not need to be located in the same physical location). The company computer 106 may connected to a database 108, and a third party database or computer 110. The company database 108 stores company data files that the user 101 can access through the communications network. The third party database or computer 110 may be the database or computer to which the user is attempting to copy a file (e.g., the third party database may be a hosted storage provider associated with the user but not the company). Alternatively, however, the system can prevent the user from copying files to the user's computer memory (not shown), and as such the third party database 110 is not a necessary system component.

As one skilled in the art will appreciate, the user computer 102 can be any computing device capable of connecting to the communications network 104 and receiving data from same. As such, the user computer 102 enables the user to interact with the company computer 106 to view data files. For example, the user computer 102 may be a desktop, laptop, personal digital assistant (PDA), cellular telephone such as a Smartphone, computer tablet, networked computer display, computer server, WebTV, as well as any other electronic device. As such, the user computer 102 is connected to the company computer 106 via communications network 104, which may be a single communications network or comprised of several different communications networks, which connect the system.

As one skilled in the art will appreciate, in one embodiment, communications network 104 establishes a computing cloud. A computing cloud can be, for example, the software implementing one or more of the company computer, third party database and application that is hosted by a cloud provider and exists in the cloud. The communications network 104 can be a combination of a public or private network, which can include any combination of the Internet and intranet systems that allow a plurality of system users to access the company computer 106. For example, communications network 104 can connect all of the system components using the internet, a local area network (“LAN”) such as Ethernet or Wi-Fi, or wide area network (“WAN”) such as LAN to LAN via internet tunneling, or a combination thereof, using electrical cable such as HomePNA or power line communication, optical fiber, or radio waves such as wireless LAN, to transmit data. As one skilled in the art will appreciate, in some embodiments, user computer 102 may be connected to the communications network using a wireless LAN, but other users may be connected to the company computer 106 via a wired connection to the internet (e.g., to set up an account from a desktop or laptop computer). In other embodiments, a user may connect to the company computer 106 using a wireless LAN and the internet to set up an account. Moreover, the term “communications network” is not limited to a single communications network system, but may also refer to several separate, individual communications networks used to connect the user computer 102 to company computer 106. Accordingly, though each of the user computer 102 and company computer 106 is depicted as connected to a single communications network, such as the internet, an implementation of the communications network 104 using a combination of communications networks is within the scope of the invention.

As one skilled in the art will appreciate, the communications network 104 interfaces with company computer 106, preferably via a firewall (not shown) and web server (not shown) to provide a secure access point for users 101 and to prevent users 101 from accessing the various protected portions of the database 108 in the system. The firewall may be, for example, a conventional firewall as discussed in the prior art. Importantly, embodiments of the invention supplement the data security in addition to the firewall (e.g., the firewall can be used with embodiments of the system, computer program product and computer-implemented method).

Returning to FIG. 1, database 108 communicates with and uploads data files to the user computer 102 via the company computer 106 and communications network 104. As one skilled in the art will appreciate, though database 108 is depicted as computer storage, database 108 may be implemented in, one or more computers, file servers and/or database servers. As such, the database 108 may be implemented as network attached storage (NAS), storage area networks (SAN), direct access storage (DAS), or any combination thereof, comprising for example multiple hard disk drives. Moreover, each of these file servers or database servers may allow a user 101 to upload data files to the database. For example, a user may have an associated username, password, RSA code, etc., that allows the user to store various files to database 108. These files can be stored in one or more computers comprising the database 108 in a plurality of software databases, tables, or fields in separate portions of the file server memory (e.g., employee records, corporate records, projects, meeting items and agendas, memos, email, letters, financial and account information, payroll records, HR records, etc.). Accordingly, as is known in the art, the computer implementing database 108 may have stored thereon database management system (e.g., a set of software programs that controls the organization, storage, management, and retrieval of data in the computer). As one skilled in the art will appreciate, in some embodiments, database 108 may be a software database stored in the company computer memory (to be discussed below). As one skilled in the art will also appreciate, though database 108 is depicted as connected to, or as a part of, the company computer 106 (and not the communications network 104), the database 108 may be, for example, a remote storage connected to the company computer 106 via the cloud or connected to the company computer 106 via a privately networked system.

Third party storage database 110 is different from a company associated database. For example, the third party storage database 110 may be provided by a third party so that user can back up data files without the use of a USB or other storage device. As such, third party storage database 110 enables a user to associate a company data file with an authorized user, as opposed to the company (e.g., to copy a data file in the company database 108 to the third party database 110 and associated with the user). Accordingly, the third party storage database 110 may arrange user data files by user account information (e.g., the database may associate the user name and password with the data files in the system, and arrange each as separate databases, tables and/or fields). Moreover, the third party storage database 110 may be, for example, implemented in, one or more computers, file servers and/or database servers. As such, the database 108 may be implemented as network attached storage (NAS), storage area networks (SAN), direct access storage (DAS), or any combination thereof, comprising for example multiple hard disk drives. These files can be stored in one or more computers comprising the database 108, in a plurality of software databases, tables, or fields in separate portions of the file server memory (e.g., user records, user account information, system administrator access and information, etc.). Accordingly, as is known in the art, the computer implementing database 108 may have stored thereon database management system (e.g., a set of software programs that controls the organization, storage, management, and retrieval of data in the computer).

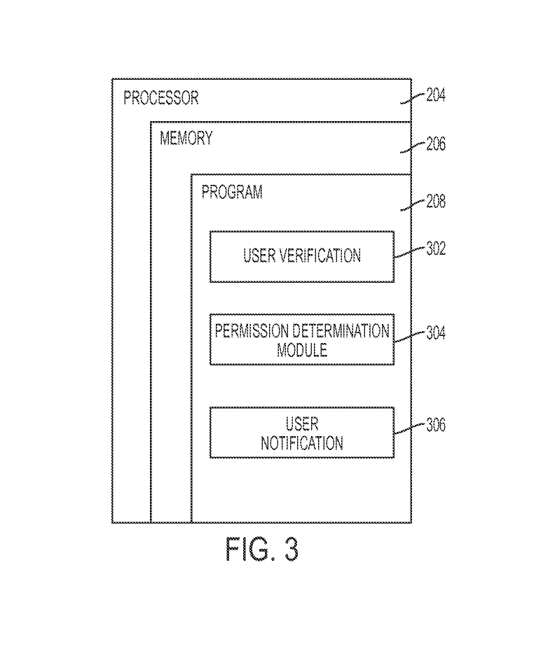

Company computer 106 will now be described with reference to FIG. 2. As one skilled in the art will appreciate, company computer 106 can be any type of computer such as a virtual computer, application server, or a plurality of computers (e.g., a dedicated computer server, desktop, laptop, personal digital assistant (PDA), cellular telephone such as a Smartphone, computer tablet, WebTV, as well as any other electronic device). As such, company computer 106 may comprise a memory 206, a program product 208, a processor 204 and an input/output (“I/O”) device 202. I/O device 202 connects the company computer 106 to a signal from the communications network 104, and can be any I/O device including, but not limited to a network card/controller connected by a bus (e.g., PCI bus) to the motherboard, or hardware built into the motherboard to connect the company computer 106 to various file servers or database servers implementing database 108.

As can be seen, the I/O device 202 is connected to the processor 204. Processor 204 is the “brains” of the company computer 106, and as such executes program product 208 and works in conjunction with the I/O device 202 to direct data to memory 206 and to send data from memory 206 to the various file servers and communications network. Processor 204 can be, for example, any commercially available processor, or plurality of processors, adapted for use in company computer 106 (e.g., Intel® Xeon® multicore processors, Intel® micro-architecture Nehalem, AMD Opteron™ multicore processors, etc.). As one skilled in the art will appreciate, processor 204 may also include components that allow the company computer 106 to be connected to a display (not shown), keyboard, mouse, trackball, trackpad and/or any other user input device, that would allow, for example, an administrative user direct access to the processor 204 and memory 206.

Memory 206 may store the algorithms forming the computer instructions of the instant invention and data, and such memory 206 may include both non-volatile memory such as hard disks, flash memory, optical disks, and the like, and volatile memory such as SRAM, DRAM, SDRAM, and the like, as required by embodiments of the instant invention. As one skilled in the art will appreciate, though memory 206 is depicted on, for example, the motherboard of the company computer 106, memory 206 may also be a separate component or device connected to the company computer 106. For example, memory 206 may be flash memory or other storage.

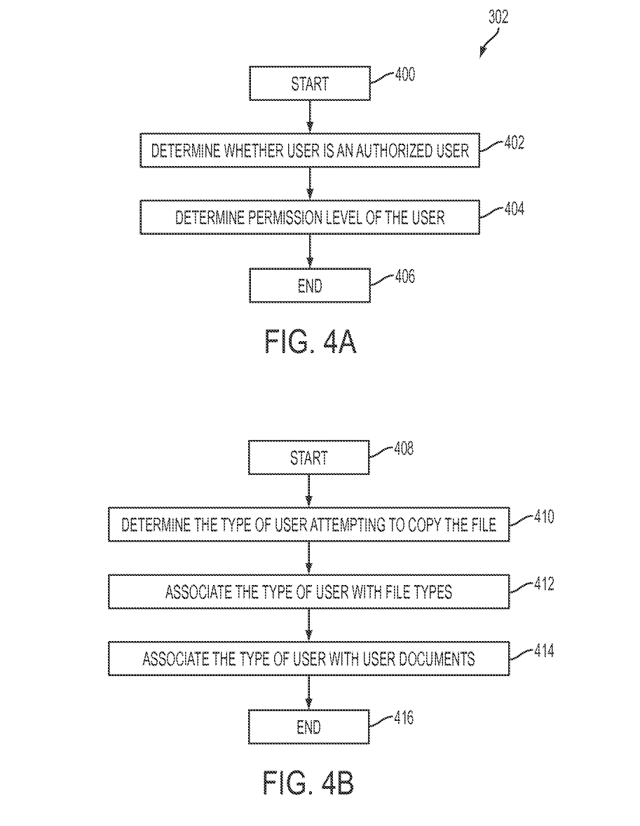

As shown in FIG. 2, an embodiment for computer instructions implementing some of the functionality of the instant invention is stored in memory 206 (e.g., as a plurality of programming modules). Turning now to FIG. 3, the programming modules of the computer instructions 208 stored in memory 206 may include a user verification module 302, a permission determination module 304, and a user notification module 306. The user verification module 302, for example, includes instructions that allow a user to logon to a company computer to retrieve data files and/or create or modify data files stored in the company computer 106 or database 108. For example, if a user 101 is accessing the company computer in a company building on a secure network, the user verification module may only include the verification of the user's login id and the user's password. However, in some instances, the user may attempt to access the company computer via a home computer, laptop, tablet, smartphone, etc. In such instances, the user verification module may include additional security checks such as RSA code verification, secure network interface login prompts, etc. Still in other embodiments, the user verification module may also include software that enables the company computer to determine whether the user is accessing the company computer via a secure or public network, or a personal or public computer. In such embodiments, the user verification module may reduce the number of permissions the user is granted if it is determined that the user is on the public network as part of the verification module.

Turning to the permission determination module 304, once a user is logged in, in some embodiments the computer program determines the level of permissions associated with the user and a user profile. For example, in some embodiments, the user may be an executive level user that can access corporate financials and human resources (HR) records for a plurality of employees that work for the user. In such instances, the permission determination module may associate the user with a level of permission that permits access to these types of files. However, other users such as a file clerk, may have access to company email, but would be restricted from corporate financial files and HR records. The permission determination module may also grant permissions to the user based upon who created the associated file (e.g., if a user creates a file, the user will have a permission level associated with accessing the created file). In other instances, the permissions module may assign users different permissions for different actions. Some users may have access to particular files for some actions but no other actions. For example, some users may only have read only access to some files (not writing to the file), some users may only be able to modify some files (read and write to the file but no copying or transmission of the file), and/or some users may have full access to files (permission to modify, copy, print, transmit, etc.). In some embodiments, after the permission level of the user is determined, the permission determination module may perform a series of checks to check for each of a plurality of copying rules for a particular file type. For example, the company may designate some file types as read only for everyone (e.g., draft financial reports), in which case any request to copy such files would be denied. In other instances, the file type would be checked against the user permissions in the filtering process. In such instances, if a user only has modify permission, but not copying permission, the copying of the file would be denied. Moreover, in some embodiments, the determination of the permissions for the file may be implemented as one or more inspection modules (e.g., each of the inspection modules implements a check for copying permissions). In such instances, one inspection module may check that the user is authorized to access the file, another inspection module may check that the file is authorized for copying, another inspection module may check that the user has copying permissions to the file, and/or another inspection module may check for restricted data in the file (e.g., the inspection module may scan the file to check that corporate signatures, redlined documents, confidential project names, etc. are not in the file being copied).

In the user notification module 306, the computer program informs the user as to whether the user can copy the file to a third party site or the user's computer. In such instance, the user notification module 306 may include an error message and/or a notification message that alerts the user that they do not have adequate permissions to copy the file from the company computer. In some embodiments, the user notification module may also update a system administrator that a restricted file was copied. In other embodiments, the user notification module may prompt the user to request access or permission from the system administrator for copying the data file. In such instances, a company may designate a person to approve such requests.

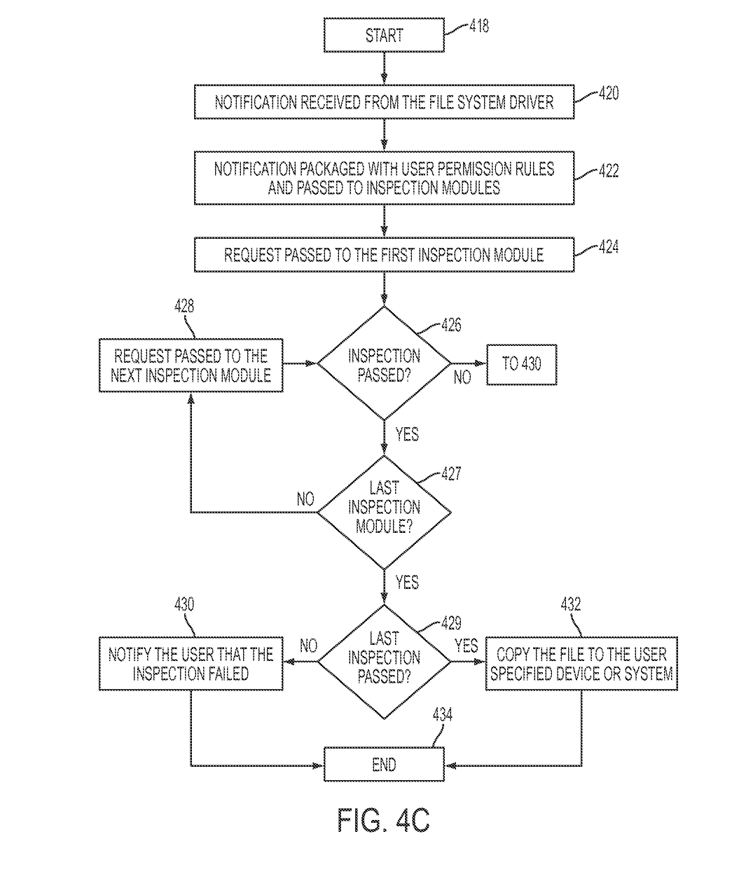

An exemplary embodiment of the computer program flow for processes implementing the user verification module 302, the permission determination module 304 and the user notification module 306 will now be described with reference to FIGS. 4A-4D. As one skilled in the art will appreciate, though the flow diagrams are shown as implemented in a serial configuration (or a combination of serial and parallel configurations), such flow is for simplicity only and should be understood to include various loops and processes that may be run separately and/or concurrently and/or used to implement each of the instructions, or a plurality of the instructions, therein. In general, the user verification module of FIG. 4A is implemented, for example when a user logs in and grants the user access to the company computer. In general, the permissions determination module portion of FIG. 4B is implemented, for example, at the user account set-up and/or after the user accesses the company computer in the user verification module of FIG. 4A. The portion of the permissions/determination module shown in FIG. 4C is implemented when the user attempts to perform an action (e.g., copying a file to a third party site or the user computer, modifying files, storing files in the database 108, emailing files, etc.) in the system that the company has restricted. The notification module of FIG. 4D is implemented to report the results of the permissions/determination module shown in FIG. 4C.

To implement the user verification 302, as shown in FIG. 4A, the process starts at step 400. In step 402, the process determines whether the user is an authorized user. In some embodiments, this determination is made on the basis of the user login identification (“user ID”) and password. In other embodiments, such as when a user is logging into the system remote from the company computer, the determination of whether the user is an authorized user may include additional steps. For example, in some embodiments, the user may be required to log in with a specific code such as an RSA code provided to the user on a key fob or as an icon on a company issued computing device. In other embodiments, the remote log in page may include additional security questions such as prompting the user for their mother's maiden name, or the best man at their wedding. Yet in other embodiments, the user verification module may determine the user is an authorized user via software loaded onto a company issued computing device (e.g., the configuration of a company issued laptop, SmartPhone, tablet, etc., used for remote access). Moreover, any combination of the above procedures for verifying that a user is an authorized user may be implemented in the system. Once it is determined that the user is an authorized user, in step 404, the system determines the permission level of the user. Such a permission level may be a basic permission level designation indicating, for example, which databases and documents the user can access based upon company status (e.g., a company officer, an administrative assistant, a mailroom attendant, an accountant, etc.). As one skilled in the art will appreciate, the initial permission determination determines which files the user can access. In step 406, the process ends.

The permission determination module 304 is described with reference to FIGS. 4B and 4C. For example, FIG. 4B shows the process steps for determining a user's permissions, or more appropriately permission rules for the user, for copying. FIG. 4C shows the process steps for determining whether the user can copy a file based upon company rules. Referring to FIG. 4B, in step 408, the process for associating the user with permission rules starts, and in step 410, the computer determines the type of user attempting to copy the file. For example, the computer may determine the type of user attempting to access the file based upon a combination of rank in the company, job task, department, etc. For example, an administrative assistant user may have access to documents for his/her supervisor because of job task but not copying privileges because of status in the company as an assistant as opposed to a supervisor. Once the user type has been determined, the system may associate with the user rules for the types of files the user can copy in step 412. As in the above example, some employees may have access to files, but may not have permission to copy the files to third party sites (e.g., the user permissions rule would restrict the user from copying files of a certain type). Reasons for this restriction may include, for example, a determination that the files contain confidential personnel or business records, corporate financial data, accounting or audit records, draft earnings reports, etc., may subject the company to civil and criminal liability if they are subject to unauthorized public dissemination. In some instances, however, a user may have legitimate reasons for copying such files. For example, an executive is traveling abroad and would prefer to use the third party site as opposed to a USB to edit corporate documents. As another example, an administrative assistant would like to save a batch of letters, filings, or other documents to edit over a weekend. In such instances, the process would differentiate user rules based upon the user type. For example, the executive may have permission to copy financials so the process associates rules for copying financials with the executive. And the administrative assistant may have permission to copy form letters so the system associates rules for copying form letters with the administrative assistant. In step 414, the process may associate the user with the user's own data files (e.g., the files that the user has created and/or edited in the company system). For example, if the administrative assistant uploaded a photo of her cat, the administrative assistant would be associated to the photograph in the system for the purpose of establishing file permissions (e.g., the permission rule would be that user internet uploads are available for copying). In step 416 the process of associating the user with a set of rules is terminated. As one skilled in the art will appreciate, the process of associating users with particular rules may be initiated upon system set-up (e.g., the permissions are entered when the user's account is set-up with the company computer). In other instances, the rules may be dynamically assigned to the user (e.g., in instances where new regulations require different security levels for different types of company information such as customer identification, employee identification, SEC disclosures, etc.). As such, the permissions rules discussed above, or other permission rules deemed necessary by the company, may be implemented and are within the scope of the disclosure.

Once user copying permissions rules are established for a user, when the user attempts to copy a file to a third party website, the copying determination step portion of the permissions determination module, shown in FIG. 4C, is implemented. In step 418, the process starts, and in step 420 the system receives notification from the computer that the user would like to copy a file from the company computer (e.g., notification is received from the operating system, the database management software and/or file system driver). In step 422, the notification is packaged with the user permission rules, discussed above, and passed to inspection modules for inspection based upon the permissions and/or other company defined parameters. In step 424, the request is passed to the first inspection module for inspection and the result is passed back to the inspection platform (e.g., the first inspection module inspects the file based upon a company defined rule for copying). If the inspection passes, in step 426, then the process determines whether the inspection module is the last inspection module in 427, and if not, the next inspection module inspects the content (e.g., based upon another company designated rule) in step 428. If the inspection does not pass, the copying request is denied and the user is notified in step 430. As one skilled in the art will appreciate, if the inspection module is the last inspection module, then the process determines if the last inspection passed in step 429. If the last inspection does not pass, the user is notified that the inspection has failed in step 430. If the last inspection passes, then the user is allowed to copy the file (e.g., either at the user request or automatically) in step 432. In step 434, the process ends.

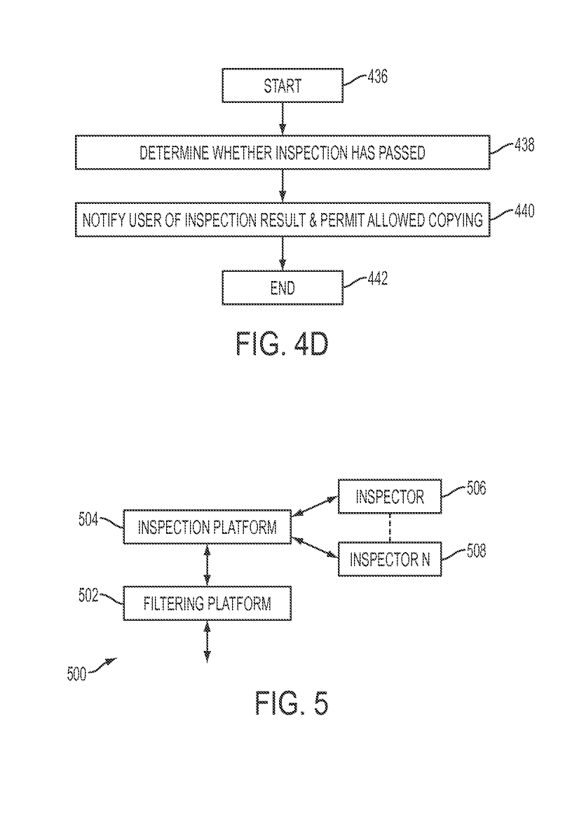

Turning to FIG. 5, the inspection process described above is shown. For example, if the user wishes to copy a file in the company database or stored on the company computer, the user requests to copy the file from, for example, a filtering platform 502. Filtering platform 502 may be a software platform for executing the instructions herein, or in some embodiments may be an operating system running on the company computer and interacting with computer memory. The filtering platform 502 sends the request to the inspection platform 504, which includes several inspection modules 506. Each of the inspection modules may include specific rules that will result in the system either granting or denying the request to copy the file. For example, the user rules discussed above, file type, user type, and whether or not the user file is user created may all be one level of inspection. In addition, the company may define more detailed inspection rules. For example, some inspection modules may scan the data file for company signatures, others may scan the file for certain data (e.g., social security numbers, bank account routing information, SEC data, health records, diagnosis, etc.), depending upon the organization implementing the system. And, other inspection modules may inspect for file type based upon document keywords (e.g., in instances where the company wants to inspect the data file based upon high level profile information and content). As one skilled in the art will appreciate, each of the inspection modules can be defined to protect the company computer from copying that may be problematic for that particular business. For example, a law firm may restrict the copying of all documents that include the word memorandum anywhere in the document to protect client information, while a computer company may restrict such documents only if they also include the word confidential. Or, a hospital or doctor's office may restrict the copying of patient records, insurance information, diagnosis, social security numbers, etc. In this way, the inspection modules can be customized for the company or organization. Once the inspection is complete, the results of the inspection are passed from the inspection platform to the filtering platform and to the user. In some embodiments, the filtering platform may initiate a user interface or dialog box reporting the result of the inspection. In other embodiments, the user dialog box or user interface may only be initiated if the inspection fails (e.g., so that the user can request access to the file for copying from a system administrator). As one skilled in the art will appreciate, the various inspections may be part of a single computer processing module or block of computer code, and as such each inspection represents a scan of the data file (e.g., the data file is scanned for each of the permissions and rules for file copying). As such, each inspection module may be implemented as computer code to perform the scan, with the result of each scan being stored in memory as a variable that initiates the computer code implementing the next inspection module to scan the data file.

Returning to FIG. 4D, the user notification module 306 is described. In step 436, the process starts, and in step 438, the process determines whether or not the inspection has passed. As discussed above, the determination may be made via a flag or other indicator reported as a result from the inspection module that the process reads, for example, from memory. In some embodiments, however, the inspection platform may initiate the process with the result reported therein in which case the process would not need to read an inspection result from memory (e.g., in the case where steps 438 and 440 are combined into one process step). Once the inspection result is determined, the process then formats the result in a user friendly format, such as a GUI in step 440. In some embodiments the GUI may only report a successful result as it allows the user to complete the copying action (e.g., in instances where the inspection platform is initiated once the user selects “copy” or “copy to clipboard” from the user application). In other instance, the GUI may prompt the user to complete the file copy by asking the user for a target site or address to send the file. Still in other embodiments, the user may complete the file copy to a clipboard by selecting a prompt to do so after the inspection result grants the user permission for same. In most embodiments, however, a user GUI is provided to the user if the inspection fails (e.g., the user is not able to copy the file). In these instances the GUI may include contact information for a system administrator that may grant the user permission to copy the file and override the inspection result. As one skilled in the art will appreciate, though the above description is related to copying a file to a third party database and/or a user computer, the embodiments above can be adapted for use with accessing a file, modifying a file, deleting a file, moving a file or any other action that a company may wish to restrict a user from taking. Accordingly, in such embodiments, the inspection modules would be adapted to inspect of a restricted action in addition to the content, user and permissions level inspections discussed above. In step 442, the process ends.

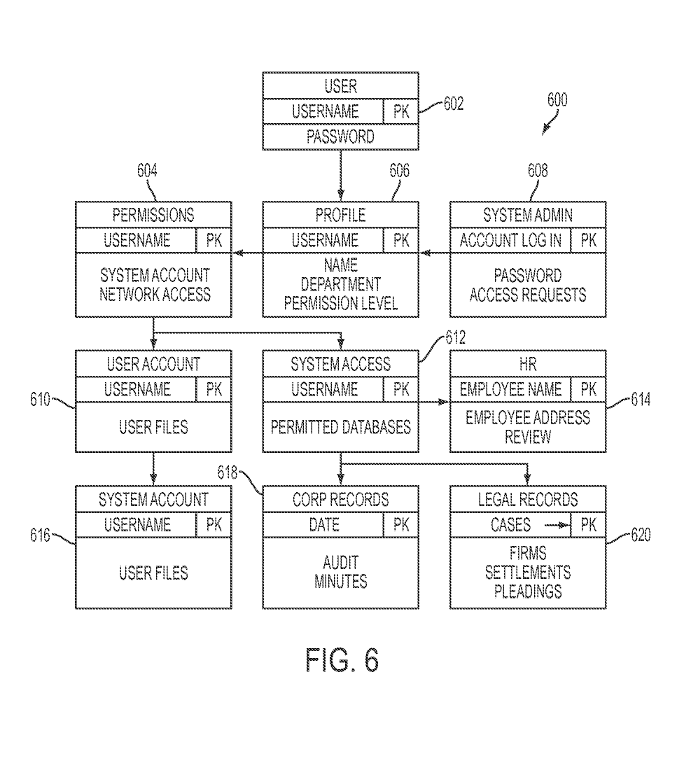

Turning to FIG. 6, an exemplary database 600 (which may be part of the physical database 108) is organized into several tables for each of the steps described in FIGS. 4A-4D, including, for example, a user login table 602, a permissions table 604, a user profile table 606, a system administrator table 608, a user account table 610, a system access table 612, a system account table 616, and a plurality of department specific tables (e.g., an HR table 614, a corporate records table 618 and a legal records table 620). As one skilled in the art will appreciate, the database 600 may be partitioned into one or more tables and/or databases specific to particular departments, titles or job functions and may include several tables other than those described above. Moreover, the tables for each of the departments may be a catalogue referring to memory or data locations storing or containing the record in the table. As such, for example, the corporate records table may only index corporate records for retrieval and may not contain the records themselves. Returning to the database diagram, the user login table 602 may include a username as the primary key (e.g., usernames are rows in the database table) and a user password as a column identifier (e.g., the password is stored in columns in the database table). The permissions table 604 may include the user name as a primary key and the system account associated with the user in addition to various permission rules established for the user as column identifiers. The profile table 606 may include the user name as a primary key and the user's actual name, department, and permission level (e.g., employee rank) as column identifiers. The system administrator table 608 may include the administrator login as a primary key, administrator password, and a list of access requests as column identifiers. The user account table 610 may include the username as a primary key and links to user files (e.g., files uploaded or stored in my documents or my uploads) as column identifiers. The system access table 612 may include the username as a primary key and a list of databases the user has access to as column identifiers. The system account table 616 may include a username as a primary key and a user files as column identifiers. The HR table 614 may include an employee name or identifier as the primary key and various employee information as the column identifiers. The corporate records table 618 may include a date as a primary key and various audit reports, minutes, etc. as column identifiers. And the legal records table 620 may include any suitable column identifier or combination of column identifies, including, for example, case identifiers as the primary key, a firms contact information, settlements, pleadings etc.

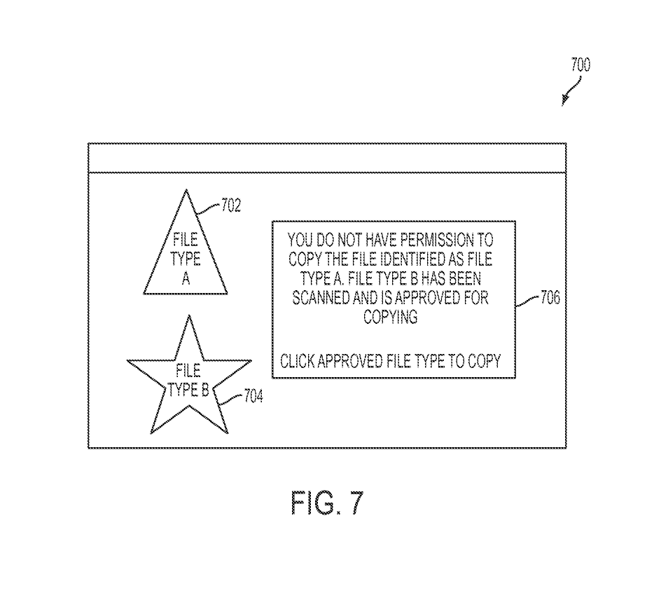

As one skilled in the art will appreciate, each of the relational tables may be used to construct GUIs as described for the program product above that allow a user to interact with the computer program of the instant invention, and exemplary GUIs and their functions will be described with reference to FIG. 7.

As shown in FIG. 7, the user interface may be limited to a GUI indicating the results of the inspection. For example, GUI 700 may appear when the results of the file inspection are obtained. As such, the inspection screen may include one or more target files for copying, such as file type A 702 and file type B 704. If the user selects both files for copying (e.g., by selecting to move the files to the clipboard or dragging same into an email or third party web interface), the inspection begins, and a result screen 706 appears with the result of the inspection. In some cases, as in the exemplary GUI, one or more file types may be approved for copying while others are rejected. In some embodiments, the result of the inspection may prompt the user to click on the approved files to finish copying the file. However, in other embodiments, the system may complete the request for the approved files and provide the prompt indicating the inspection has failed for those files that failed inspection.

As one skilled in the art will further appreciate the display page of FIG. 7 is exemplary of the GUIs that may be initiated by the computer program of the instant invention to perform the inventive functions herein (e.g., user cancellation GUI, a copied files log GUI, an administrator override GUI, etc.). Other GUIs may be created that will help with efficiency of data entry, add additional features, or further enable setting permissions and rules for the inspection modules, and accordingly not all embodiments of such GUIs have been described herein, but will be apparent to one of skill in the art. Accordingly, various GUIs may be used instead of or in addition to the GUIs described herein, and the GUIs are in no way to be considered limiting to the specification and claims, but are used for a descriptive sense only.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

What is claimed is:

1. A system for storing data files, the system comprising:
a computer having a processor and a tangible, non-transitory computer memory with instructions operable therein for performing on the processor a process of connecting a user to a storage device and a process of determining whether a data file selected by the user can be copied from the storage device to a third party storage device, the instructions comprising the steps of:
determining whether the user is attempting to access the storage device to copy the selected data file to the third party storage device;
determining at least one of:
whether the user is authorized to copy the selected data file to the third party storage device,
whether the selected data file is of a type that cannot be copied to the third party storage device, and
whether the selected data file includes restricted data that cannot be copied to the third party storage device; and
preventing the user from copying the selected data file to the third party storage device when the computer determines that at least one of: the user is not authorized to copy the selected data file, the selected data file is of the type that cannot be copied, and the selected data file includes restricted data.

2. The system of claim 1, wherein:
the computer further comprises one or more inspection modules operated by the processor; and
the computer memory includes the instructions that further comprise at least one of the steps of:
scanning the selected data file using the one or more inspection modules, wherein each of the one or more inspection modules scans the selected data file according to a rule assigned to the one or more inspection modules for determining whether the selected data file contains restricted data,
scanning a user profile using the one or more inspection modules wherein each of the one or more inspection modules scans the user profile according to a rule assigned to the one or more inspection modules for determining whether the user is authorized to copy the selected data file to the third party storage device,
scanning a file profile associated with the selected data file using the one or more inspection modules wherein each of the one or more inspection modules scans the file profile according to a rule assigned to the one or more inspection modules for determining whether the selected data file is of a type that cannot be copied to the third party storage device, and
granting the user permission to copy the selected data file to the third party storage device when the computer determines that the user is authorized to copy the selected data file, the selected data file is of a type that can be copied, or the selected data file does not include restricted data.

3. The system of claim 2,
wherein the rule assigned to a first of the one or more inspection modules includes a first data type and the first data type includes at least one of a social security number, a corporate signature, a bank account routing number, credit card information and customer account information; or
wherein the rule assigned to a second of the one or more inspection modules includes a search by a second data type and the second data type includes at least one of an address, insurance information, a patient record identifier, a health record, a medical test result and a diagnosis.

4. The system of claim 2 wherein the computer memory includes the instructions that further comprise the step of:
assigning at least one of the one or more inspection modules to enable the processor to inspect the selected data file for user permissions to perform at least one task, wherein the task comprises at least one of modifying the selected data file, reading the selected data file, editing the selected data file, saving the selected data file, and attaching the selected data file to an email message.

5. The system of claim 2 including instructions executed by the processor,
wherein permission to access files is established by a system administrator upon establishing the user is an authorized user, and the administrator has access to change the permissions to the user, and
wherein the third party storage device is a user computer associated with the user and connected to the computer via a communications network.

6. The system of claim 2, the computer further comprises:
a filtering platform causing the processor to determine whether a request is being received by the computer to copy the selected data file, and
an inspection platform, responsive to the filtering platform, for causing the processor to operate the one or more inspection module, the one or more inspection module determining whether the user is authorized to copy the selected data file, the selected data file is of a type that cannot be copied to the third party storage device, or the selected data file includes restricted data that cannot be copied to the third party storage device, receiving inspection results from the one or more inspection modules, and reporting the inspection results to the filtering platform.

7. The system of claim 6, wherein the inspection platform causes the processor to operate each of the one or more inspection modules in series such that the selected data file only passes from a first of the one or more inspection modules to a second of the one or more inspection modules for inspection when the first of the one or more inspection modules determines the selected data file can be copied.

8. A computer program product operable on a computer having a tangible, non-transitory computer memory, the computer program product causing the computer to perform a process of connecting a user to a storage device and a process of determining whether a data file selected by the user can be copied from the storage device to a third party storage device, the computer program product executing instructions comprising the steps of:
determining whether the user is attempting to access the storage device to copy the selected data file to the third party storage device;
determining at least one of:
whether the user is authorized to copy the selected data file to the third party storage device,
whether the selected data file is of a type that cannot be copied to the third party storage device, and
whether the selected data file includes restricted data that cannot be copied to the third party storage device; and
preventing the user from copying the selected data file to the third party storage device when the computer determines that at least one of: the user is not authorized to copy the selected data file, the selected data file is of the type that cannot be copied, and the selected data file includes restricted data.

9. The computer program product of claim 8, wherein the computer program product comprises of one or more inspection modules and that further cause the computer to perform at least one of the steps of:
scanning the selected data file using the one or more inspection modules, wherein each of the one or more inspection modules scans the selected data file according to a rule assigned to the one or more inspection modules for determining whether the selected data file contains restricted data,
scanning a user profile using the one or more inspection modules wherein each of the one or more inspection modules scans the user profile according to a rule assigned to the one or more inspection modules for determining whether the user is authorized to copy the selected data file to the third party storage device,
scanning a file profile associated with the selected data file using the one or more inspection modules wherein each of the one or more inspection modules scans the file profile according to a rule assigned to the one or more inspection modules for determining whether the selected data file is of a type that cannot be copied to the third party storage device, and
granting the user permission to copy the selected data file to the third party storage device when the computer determines that the user is authorized to copy the selected data file, the selected data file is of a type that can be copied, or the selected data file does not include restricted data.

10. The computer program product of claim 9,
wherein the rule assigned to a first of the one or more inspection modules includes a first data type and the first data type includes at least one of a social security number, a corporate signature, a bank account routing number, credit card information and customer account information; or
wherein the rule assigned to a second of the one or more inspection modules includes a search by a second data type and the second data type includes at least one of an address, insurance information, a patient record identifier, a health record, a medical test result and a diagnosis.

11. The computer program product of claim 9, further implementing the step of:
assigning at least one of the one or more inspection modules to enable the computer to inspect the selected data file for user permissions to perform at least one task, wherein the task comprises at least one of modifying the selected data file, reading the selected data file, editing the selected data file, saving the selected data file, and attaching the selected data file to an email message.

12. The computer program product of claim 8,
wherein permission to access files is established by a system administrator upon establishing the user is an authorized user, and the administrator has access to change the permissions to the user, and
wherein the third party storage device is a user computer associated with the user and connected to the computer via a communications network.

13. The computer program product of claim 9, further comprising two processing platforms including:
a filtering platform causing the computer to determine whether a request is being received by the computer to copy the selected data file, and
an inspection platform, responsive to the filtering platform, for causing the computer to operate the one or more inspection module, the one or more inspection module determining whether the user is authorized to copy the selected data file, the selected data file is of a type that cannot be copied to the third party storage device, or the selected data file includes restricted data that cannot be copied to the third party storage device, receiving inspection results from the one or more inspection modules, and reporting the inspection results to the filtering platform.

14. The computer program product of claim 13, wherein the inspection platform operates each one of the inspection modules in series such that the data file only passes from one inspection module to another inspection module for inspection when the one inspection module determines the data file can be copied.

15. A computer implemented method causing a computer to perform a process of connecting a user to a storage device and a process of determining whether a data file selected by the user can be copied from the storage device to a third party storage device, the computer-implemented method comprising the steps of:
determining whether the user is attempting to access the storage device to copy the selected data file to the third party storage device;
determining at least one of:
whether the user is authorized to copy the selected data file to the third party storage device,
whether the selected data file is of a type that cannot be copied to the third party storage device, and
whether the selected data file includes restricted data that cannot be copied to the third party storage device; and
preventing the user from copying the selected data file to the third party storage device when the computer determines that at least one of: the user is not authorized to copy the selected data file, the selected data file is of the type that cannot be copied, and the selected data file includes restricted data.

16. The computer-implemented method of claim 15, wherein the steps are organized into one or more inspection modules that cause the computer to perform at least one of the steps of:
scanning the selected data file using the one or more inspection modules, wherein each of the one or more inspection modules scans the selected data file according to a rule assigned to the one or more inspection modules for determining whether the selected data file contains restricted data,
scanning a user profile using the one or more inspection modules wherein each of the one or more inspection modules scans the user profile according to a rule assigned to the one or more inspection modules for determining whether the user is authorized to copy the selected data file to the third party storage device,
scanning a file profile associated with the selected data file using the one or more inspection modules wherein each of the one or more inspection modules scans the file profile according to a rule assigned to the one or more inspection modules for determining whether the selected data file is of a type that cannot be copied to the third party storage device, and
granting the user permission to copy the selected data file to the third party storage device when the computer determines that the user is authorized to copy the selected data file, the selected data file is of a type that can be copied, or the selected data file does not include restricted data.

17. The computer-implemented method of claim 16,
wherein the rule assigned to a first of the one or more inspection modules includes a first data type and the first data type includes at least one of a social security number, a corporate signature, a bank account routing number, credit card information and customer account information; or
wherein the rule assigned to a second of the one or more inspection modules includes a search by a second data type and the second data type includes at least one of an address, insurance information, a patient record identifier, a health record, a medical test result and a diagnosis.

18. The computer-implemented method of claim 16, further comprising the step of:
assigning at least one of the one or more inspection modules to enable the computer to inspect the selected data file for user permissions to perform at least one task, wherein the task comprises at least one of modifying the selected data file, reading the selected data file, editing the selected data file, saving the selected data file, and attaching the selected data file to an email message.

19. The computer-implemented method of claim 15,
wherein permission to access files is established by a system administrator upon establishing the user is an authorized user, and the administrator has access to change the permissions to the user, and
wherein the third party storage device is a user computer associated with the user and connected to the computer via a communications network.

20. The computer-implemented method of claim 19, wherein the steps comprise two processing platforms including:
a filtering platform causing the computer to determine whether a request is being received by the computer to copy the selected data file, and
an inspection platform, responsive to the filtering platform, for causing the computer to operate the one or more inspection module, the one or more inspection module determining whether the user is authorized to copy the selected data file, the selected data file is of a type that cannot be copied to the third party storage device, or the selected data file includes restricted data that cannot be copied to the third party storage device, receiving inspection results from the one or more inspection modules, and reporting the inspection results to the filtering platform.
